(19) United States
(12) Patent Application Publication
(10) Pub. No.: US 2011/0299146 A1
(43) Pub. Date: Dec. 8, 2011

(54) SCANNER MOTOR

(75) Inventors: Song Bon Oh, Gyunggi-do (KR); Sang Jae Song, Gyunggi-do (KR)

(73) Assignee: SAMSUNG ELECTRO-MECHANICS CO., LTD., Gyunggi-do (KR)

(21) Appl. No.: 12/877,783

(22) Filed: Sep. 8, 2010

(30) Foreign Application Priority Data
Jun. 7, 2010 (KR) 10-2010-0053470

(51) Int. Cl. G02B 26/10

(52) U.S. Cl. 359/200.1

(57) ABSTRACT

Disclosed herein is a scanner motor. The scanner motor includes a rotating shaft which rotatably supports the motor. A housing surrounds an outer circumference of the rotating shaft, is made by impregnating resin into a porous sintered metal material, and has a groove therein.

### CROSS REFERENCE TO RELATED APPLICATION

This application claims the benefit of Korean Patent Application No. 10-2010-0053470, filed on Jun. 7, 2010, entitled “SCANNER MOTOR”, which is hereby incorporated by reference in its entirety into this application.

### BACKGROUND OF THE INVENTION

1. Field of the Invention

The present invention relates generally to a scanner motor and, more particularly, to a scanner motor which is used in an output device using optical technology, such as a laser beam printer or a scanner, so as to rotate a polygon mirror.

2. Description of the Related Art

As the market for output devices using optical technology is demanding miniaturization and high speed, an actuator for driving an optical reflecting unit such as a polygon mirror must be imparted with better performance.

The most important performance factors which are being required at present concern are the flatness of the optical reflecting unit such as the polygon mirror and the rotating center of a rotating shaft when it is in operation. Also, reducing the manufacturing cost as well as the performance is important matters to be considered.

The scanner motor is the machine which is installed in a laser beam printer or the like and rotates a polygon mirror at high speed to deflect and scan optical beams emitted from a light source. In the scanner motor, the polygon mirror that rotates at high speed must be fixedly mounted to the scanner motor. Such a conventional scanner motor is schematically shown in FIG. 5.

As shown in FIG. 5, the conventional scanner motor 10 includes a polygon mirror 11 which is provided on the upper portion of the scanner motor 10, and a spring 12 which is used to secure the polygon mirror 11 to the housing shaft 13. Such a conventional scanner motor is disclosed in Korean Patent Laid-Open Publication No. 2003-84148.

The scanner motor 10 rotates a housing shaft 13 with force between an armature (not shown) which is mounted to the outer circumference of a bearing holder (not shown) and is thus subjected to external power, and a rotor magnet 15 which is mounted to the inner circumference of the rotor case 14.

The housing shaft 13 mounts the polygon mirror 11, and the rotor case 14 is mounted to the lower portion of the housing shaft 13.

The housing shaft 13 has a disc shape, with the polygon mirror 11 mounted to the housing shaft 13. A rotating shaft 16 is inserted into the central portion of the housing shaft 13 to be secured thereto. The spring 12 is pressed against the upper portion of the housing shaft 13, thus locking the upper portion of the polygon mirror 11.

The rotor case 14 is secured to the lower surface of the housing shaft 13 using caulking, and the rotor magnet 15 is mounted to the inner circumferential wall of the rotor case 14 in such a way as to face the armature (not shown).

The polygon mirror 11 is mounted to the housing shaft 13 of the scanner motor 10 in such a way as to rotate, and reflects laser beams in a laser beam printer or the like. Here, at least part of the upper surface of the polygon mirror 11 is pressed by the spring 12 mounted to the housing shaft 13 so as to be secured to the housing shaft 13.

However, the scanner motor 10 constructed as described above is problematic in that the housing shaft 13, serving as the support part of the polygon mirror 11 and manufactured by machining, is used to ensure the flatness of the rotating shaft 16 and the polygon mirror 11, and coupling force between the spring 12 and the polygon mirror 11 is not strong, so that the spring 12 and the polygon mirror 11 are separable from the scanner motor 10 in case a strong impact is transmitted from the exterior.

Further, the spring 12 may be deformed by floating force of the polygon mirror 11 when the scanner motor 10 rotates at high speed. Thereby, the overall balance of the scanner motor 10 is impaired, so that it is impossible to obtain the stable driving characteristics of the scanner motor 10.

Accordingly, research is actively being conducted into a scanner motor which not only has stable driving characteristics when the motor rotates, but which also has excellent formability, and which is manufactured at a lower cost and therefore is price competitive.

### SUMMARY OF THE INVENTION

The present invention has been made in an effort to provide a scanner motor, which can not only have stable driving characteristics when the motor rotates, but also excellent formability, and which is manufactured at a lower cost and therefore is price competitive.

In a scanner motor according to an embodiment of the present invention, a rotating shaft rotatably supports the motor, and a housing surrounds an outer circumference of the rotating shaft, is made by impregnating resin into a porous sintered metal material, and has a groove therein.

The housing may be made of metal particles containing 50 wt % iron or copper.

Further, the housing may be sintered and then impregnated with epoxy resin.

Further, the groove of the housing may be formed to be inclined to prevent oil from leaking out.

Further, the housing may include a spiral-shaped groove so as to prevent oil from leaking out.

Further, the housing may extend from a center in a circumferential direction so as to prevent oil from leaking out.

Further, the housing may have one step or two steps therein so as to prevent oil from leaking out.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view illustrating an entire scanner motor according to a preferred embodiment of the present invention;

FIGS. 2 to 4 are top views illustrating housings of the scanner motor, according to various embodiments of the present invention; and

FIG. 5 is a sectional view illustrating a conventional scanner motor.

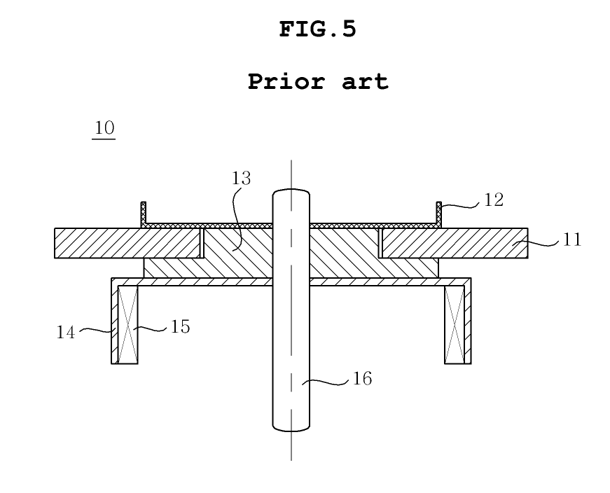

### DESCRIPTION OF THE PREFERRED EMBODIMENTS

The terminology or words used in the description and the claims of the present invention should not be interpreted as being limited merely to common or dictionary meanings. On the contrary, they should be interpreted based on the meanings and concepts of the invention in keeping with the scope of the invention on the basis of the principle that the inventor(s) can appropriately define the terms in order to describe the invention in the best way possible.

The above and other objects, features and advantages of the present invention will be more clearly understood from the following detailed description taken in conjunction with the accompanying drawings. Herein, the same reference numerals are used throughout the different drawings to designate the same components. Further, when it is determined that the detailed description of the known art related to the present invention may obscure the gist of the present invention, the detailed description will be omitted.

Hereinafter, a scanner motor according to the preferred embodiment of the present invention will be described in detail with reference to the accompanying drawings.

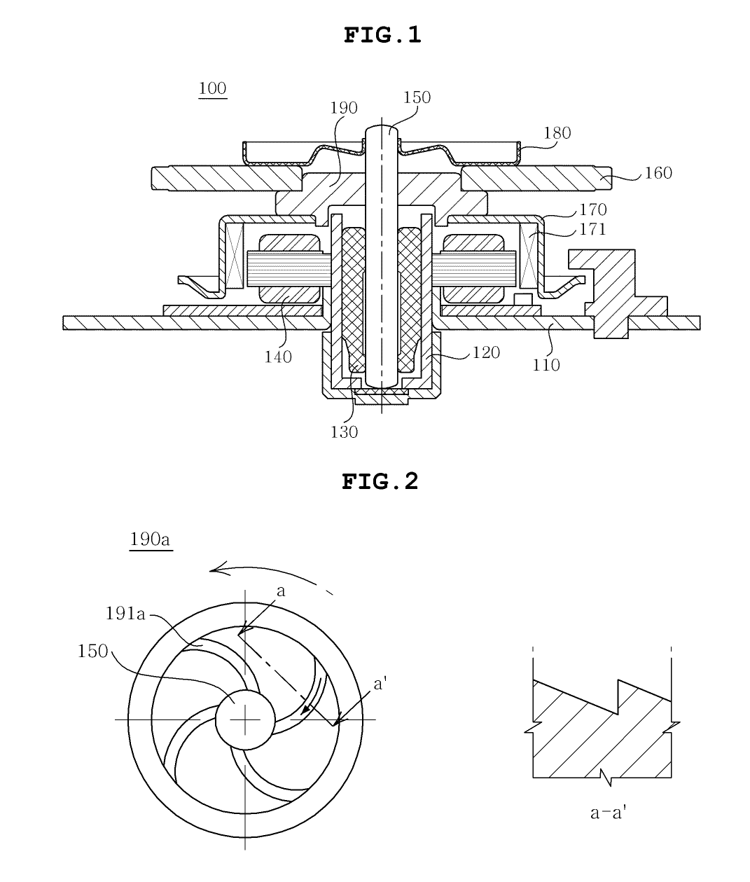

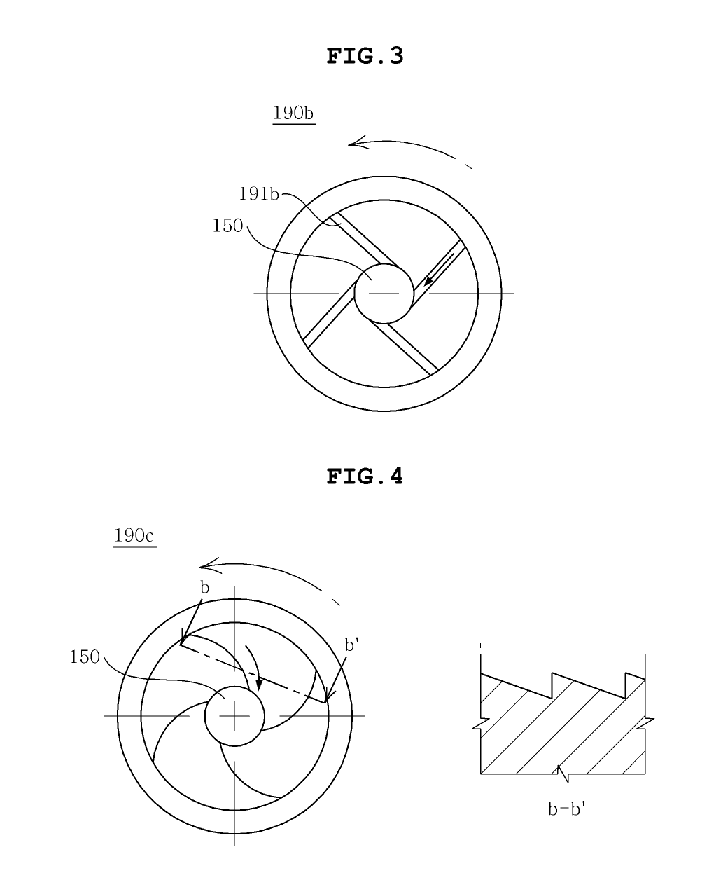

FIG. 1 is a sectional view illustrating an entire scanner motor 100 according to a preferred embodiment of the present invention, and FIGS. 2 to 4 are top views illustrating housings of the scanner motor 100, according to various embodiments of the present invention.

As shown in FIG. 1, the scanner motor 100 of the present invention includes a base plate 110, a bearing holder 120, a bearing 130, an armature 140, a rotating shaft 150, a polygon mirror 160, a rotor case 170, a locking member 180 and a housing 190.

The base plate 110 functions to support the whole portion of the scanner motor 100. A circuit board (not shown) is mounted on the upper surface of the base plate 110 to electrically control the armature 140, and the bearing holder 120 is secured to the central portion of the base plate 110.

The bearing holder 120 accommodates the bearing 130 therein to hold it, and has a hollow cylindrical shape. The bearing holder 120 is fixedly coupled to the base plate 110, with the armature 140 provided on the outer circumference of the bearing holder 120.

The bearing 130 functions to rotatably support the rotating shaft 150 inserted into the inner circumference of the bearing 130, and has a hollow cylindrical shape. The outer circumference of the bearing 130 is in close contact with the inner circumference of the bearing holder 120.

Further, a lubricant is contained between the bearing 130 and the rotating shaft 150 to allow the rotating shaft 150 to rotate smoothly.

The armature 140 is subjected to external power to form an electric field, and includes a core (not shown) and a coil (not shown) wound around the core.

The core is fixedly mounted to the outer circumference of the bearing holder 120. In order to achieve the thinness of the scanner motor 100, the core is preferably installed to be almost adjacent to the base plate 110.

The coil is placed to face a rotor magnet 171 of the rotor case 170 and forms the electric field using external power, thus rotating the rotor case 170 using the force acting between the coil and the rotor magnet 171.

The rotating shaft 150 functions to axially support the whole rotary unit of the motor 100, and is inserted into the inner circumference of the bearing 130 in such a way as to be rotatably supported by the bearing 130.

The polygon mirror 160 functions to deflect and scan optical beams emitted from a light source (not shown), and is mounted to the upper portion of the housing 190 which supports the outer circumference of the rotating shaft 150.

The rotor case 170 is secured to the housing 190 which supports the outer circumference of the rotating shaft 150. The polygon mirror 160 is seated above the rotor case 170 and the annular rotor magnet 171 is attached to the inner surface of the rotor case 170 in such a way as to face the armature 140.

The locking member 180 functions to lock the polygon mirror 160 to the housing 190, and presses the polygon mirror 160 towards the upper portion of the housing 190, thus preventing the removal of the polygon mirror 160 even when it rotates. Since the locking member 180 comprises an elastic member, it generally uses a spring.

The housing 190 is fitted over the outer circumference of the rotating shaft 150 to support the polygon mirror 160 under the polygon mirror 160, and is coupled to the rotor case 170 to support the rotating shaft 150.

Further, the housing 190 uses a sintered metal which is inexpensive, has a high degree of freedom in its shape, and has high strength so as to very precisely couple the polygon mirror 160 to the rotating shaft 150.

That is, the housing 190 is made of a porous sintered metal material comprising metal particles containing 50 wt % or more iron or copper. After a sintering process is performed by applying pressure to the metal particles, resin is impregnated into air pores which are formed after the sintering process.

When such a housing 190 is made of the porous sintered metal material using metal particles which are excellent in formability, an increase in the number of processes or the complexity of the process are obviated, thus achieving a reduction in the manufacturing cost thereof.

Meanwhile, in the housing 190 made of the porous sintered metal material, the metal particles are subjected to pressure and thus are sintered. In this case, complete alloy bonding does not take place between the metal particles, thus resulting in the air pores. This lowers the strength of the metal material.

Therefore, according to the present invention, the housing 190 is made of the sintered metal material, while the resin is impregnated into the air pores, thus preventing the strength from being reduced. In this case, the resin may use epoxy resin.

In this way, the strength of the metal material can be prevented from being reduced, concomitantly preventing the coupling force between the housing 190 and the rotating shaft 150 from being reduced, and also preventing the housing 190 from being distorted or bent by the elastic force when the polygon mirror 160 is secured to the housing 190 with high precision and high strength.

Further, the present invention can provide the scanner motor, which prevents the housing 190 from cracking even if external stress such as the impact upon being dropped acts on the motor 100, which is manufactured at a lower cost, and which realizes high-speed rotation and a high degree of precision. The housing 190 includes grooves therein to prevent oil impregnated into the sintered metal from leaking out.

The grooves of a variety of shapes which may be formed in the housing 190 will be described in detail with reference to FIGS. 2 to 4.

FIG. 2 is a top view illustrating a housing 190a according to the first embodiment of the present invention, which shows grooves 191a formed in the housing 190a in detail.

Four grooves 191a are formed in a spiral shape at regular intervals in the housing 190a. The grooves 191a divide the housing 190 into four parts when viewed from the top.

In order to make oil collect in the interior of the housing 190a when the motor 100 rotates counterclockwise, as shown in the sectional view of the housing 190a which is taken along line a-a′ of FIG. 2, the portion of the housing 190a which is in contact with the groove 191a is the deepest, and the housing 190a is inclined upwards when viewed in a counterclockwise direction from the deepest portion.

The position, number, and shape of the grooves 191a are not limited. However, in order to prevent oil from leaking out when the motor 100 rotates, each groove is preferably obliquely formed such that its central portion is deeper than its outer circumference.

As shown in FIG. 3, grooves 191b formed in a housing 190b according to the second embodiment of the present invention may have the shape of straight lines. The grooves 191b are shaped to extend from the interior of the housing 190b and face a counterclockwise direction, when the motor 100 rotates counterclockwise.

The position, number, and shape of the grooves 191b are not limited. However, in order to prevent oil from leaking out when the motor 100 rotates, each groove is preferably obliquely formed such that its central portion is deeper than its outer circumference.

As shown in FIG. 4, a housing 190c according to the third embodiment of the present invention may be formed to be inclined in two steps when viewed from a partial sectional view taken along line b-b′.

The scanner motor 100 according to the present invention constructed as described above is made of the porous sintered metal material, and the resin is impregnated into the air pores formed after the sintering process is performed to prevent the housing from cracking or being weakened by stress or strain coming from external shocks when the polygon mirror is secured to the housing. Therefore, the present invention provides the housing, which realizes the miniaturization and thinness of the motor and has competitiveness owing to its low cost.

As described above, the present invention provides a scanner motor, in which a housing is made of a porous sintered metal material comprising metal particles containing 50 wt % or more iron or copper, and resin is impregnated into air pores which are formed by the sintering process performed by applying pressure to the metal particles.

Such a housing is made of the porous sintered metal material using the metal particles which are excellent in formability, thus suppressing an increase in the number of processes and in the complexity of the process thereby realizing a reduction in manufacturing cost thereof.

Meanwhile, in the housing made of the porous sintered metal material, the metal particles are subjected to pressure and thus are sintered. In this case, complete alloy bonding does not take place between the metal particles, thus resulting in air pores which lower the strength of the metal material. In order to solve the problem, the housing of the present invention is made of a sintered metal material, and in addition, the air pores are impregnated with resin.

In this way, reducing the strength of the metal material can be prevented, thereby preventing the coupling force between the housing and a rotating shaft from being lowered and also preventing the housing from being distorted or bent by the elastic force when the polygon mirror is secured to the housing with high precision and high strength.

Further, the present invention can provide a scanner motor which prevents a housing from cracking even when an external stress such as the impact upon being dropped acts on the motor, which is cheap to manufacture, and which realizes high-speed rotation and a high degree of precision.

The housing includes a groove therein to prevent oil impregnated into the sintered metal from leaking out.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A scanner motor, comprising:
a rotating shaft rotatably supporting the motor; and
a housing surrounding an outer circumference of the rotating shaft, made by impregnating resin into a porous sintered metal material, and having a groove therein.

2. The scanner motor as set forth in claim 1, wherein the housing is made of metal particles containing 50 wt % iron or copper.

3. The scanner motor as set forth in claim 1, wherein the housing is sintered and then impregnated with epoxy resin.

4. The scanner motor as set forth in claim 1, wherein the groove of the housing is formed to be inclined to prevent oil from leaking out.

5. The scanner motor as set forth in claim 1, wherein the housing comprises a spiral-shaped groove so as to prevent oil from leaking out.

6. The scanner motor as set forth in claim 1, wherein the housing extends from a center in a circumferential direction so as to prevent oil from leaking out.

7. The scanner motor as set forth in claim 1, wherein the housing has one step or two steps therein so as to prevent oil from leaking out.
